(19) United States
(12) Patent Application Publication
(10) Pub. No.: US 2006/0109526 A1
(43) Pub. Date: May 25, 2006

(54) Case divider for organizing patient films

(76) Inventors: Daoxian H. Zhang, Los Gatos, CA (US); Patrick B. Heffernan, Campbell, CA (US); Yue Shen, Santa Clara, CA (US)

Correspondence Address: Pamela R. Crocker;Patent Legal Staff, Eastman Kodak Company, 343 State Street, Rochester, NY, 14650-2201, US

(21) Appl. No.: 11/273,129

(22) Filed: Nov. 14, 2005

Related U.S. Application Data
(60) Provisional application No. 60/631,155, filed on Nov. 24, 2004.

(51) Int. Cl. H04N 1/04

(52) U.S. Cl. 358/487

(57) ABSTRACT

An apparatus and method for scanning a set of film images for a patient. A set of film images is assembled for scanning, and a case divider is provided at the beginning or end of the set of film images to serve as an indicator that differentiates the set of film images from any other film images to be scanned. The case divider is disposed on a separate sheet and bears a pattern that indicates its function as a case divider. The set of films is scanned along with the case divider to obtain scanned image data. The case divider pattern is detected in the scanned image data to identify the case divider.

### CROSS REFERENCE TO RELATED APPLICATIONS

Reference is made to, and priority is claimed from, provisional application U.S. Ser. No. 60/631,155, entitled “CASE DIVIDER FOR CAD TO ORGANIZE FILMS”, filed on Nov. 24, 2004, in the names of Zhang et al, and which is assigned to the assignee of this application.

### FIELD OF THE INVENTION

The invention generally relates to handling and organization of medical images for digitization, and more particularly relates to a method and apparatus for organizing patient images on film for scanning.

### BACKGROUND OF THE INVENTION

The benefits of computer-aided diagnosis (CAD) in radiology, and particularly in mammography, have been recognized. CAD systems for mammography screening provide improvement in the detection of breast cancer, helping to diagnose this condition at stages of the disease during which treatment has been shown to be generally more successful than at later stages.

In conventional workflow for mammography, X-ray images, originally obtained on film, are input to a high-resolution scanner for digitization. The digitized image data is then available to the CAD system that performs a sequence of image processing procedures designed to identify areas of interest to the diagnostician. In typical operation, multiple films are obtained for each patient, with different views taken of each breast. Usually, there are two images associated with each breast: a top view ordinarily termed a craniocaudal (CC) view, and lateral view ordinarily termed a mediolateral oblique (MLO) view. Thus, mammography films for each patient are commonly provided in groups of four. However, there may be more or fewer than four films obtained at one time for any patient.

Referring to FIG. 1, there is shown a conventional CAD system 10 having a scanner 12 for digitizing films 20 containing film images from mammography or other medical images for multiple patients. Patients A and B each have four film images in the example shown in FIG. 1. Scanner 12 has an input feed slot 14 (that may also serve as an output tray in some embodiments) for inputting/feeding films 20 and an operator control panel 16 for entry of operator commands for scanner operation and for entering identifying patient data. A barcode scanner 18 is employed to aid in correlating films 20 to each patient. Scanner 12 digitizes each film 20 and provides the digital image data to a workstation 22 or other computerized device that executes the CAD image analysis software for diagnosis. There are known variations to the basic system used for image digitization and analysis shown in FIG. 1. For example, the function of control panel 16 may be performed at a keyboard at workstation 22 or on a touch screen or using some other method for operator interface.

While the conventional CAD system solution shown in FIG. 1 performs the basic task of identifying patient films by barcode scanning, there are a number of inherent drawbacks to standard approaches and conventional processing techniques that have been employed to date. The requirement that barcode scanner 18 be provided as part of scanner 12 adds cost to the scanner unit and constrains the processing workflow, requiring that a barcode be provided on each piece of film 20 or on some other component provided with films 20. Barcode imaging onto each piece of film 20 is a solution that requires separate operations for personnel using the imaging or processing systems for patient films 20 and may not be a desirable solution for many imaging environments. Scanning of a separate file cover, envelope, card, container, or other article that accompanies or encases films 20 requires a separate operator step and places constraints on the overall operating sequence for scanner 12.

Scanner 12 for CAD systems is a high-speed, high-resolution device. For mammography and other X-ray applications, scanner 12 is monochromatic, obtaining density information for each pixel, with typical resolutions of at least 50 micron or higher. The type of scanners used for this application operate at high speeds, so that, where operator procedures are suitably streamlined, film images for multiple patients can be processed without excessive waiting times. It can be appreciated that there would be benefits to system solutions that optimize the efficiency of scanner workflow, enabling high speed scanning and processing and taking advantage of inherent capabilities of the scanner itself in order to differentiate image data of one patient from image data of another, and that would allow films for multiple patients to be stacked together for sequential processing by the scanner, without interrupting scanner operation for each set of patient images.

### SUMMARY OF THE INVENTION

The present invention provides a method for scanning a set of film images for a patient. The method comprises several steps: a) assembling the set of film images for scanning; b) disposing a case divider at the beginning or end of the set of film images to serve as an indicator that differentiates the set of film images from any other film images to be scanned, wherein the case divider is on a separate sheet and bears a pattern that indicates its function as a case divider; c) scanning the set of films along with the case divider to obtain scanned image data; and d) detecting the case divider pattern in the scanned image data to identify the case divider.

The present invention provides a case divider that can be efficiently scanned to demarcate separate sets of patient images.

An advantage of the present invention is that it provides a flexible method for differentiating images for different patients, adaptable to various workflow arrangements and image identification methods.

Another advantage of the present invention is that it provides an automated method for separating or differentiating sets of images for scanning without requiring a separate bar code scanner.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings. The elements of the drawings are not necessarily to scale relative to each other.

FIG. 1 is a block diagram of a conventional image scanning system that can be used for scanning mammography or other types of X-rays from film.

FIG. 2 is a flow diagram showing the scanning sequence according to one embodiment of the present invention.

FIG. 3 is a flow diagram of a scanning sequence that is executed by the scanner according to pre-programmed instructions.

FIG. 4 is a perspective view showing a group of case dividers.

FIG. 5 is a diagrammatic view showing the use of case dividers for separating the images for multiple patients.

FIG. 6 is a perspective view showing case dividers and patient images loaded into a scanner in one embodiment.

FIGS. 7A, 7B, 7C, and 7D are plan views showing tabbed and color-encoded case dividers.

FIG. 8 is a plan view of a marking used on a case divider in one embodiment.

FIG. 9 is a table listing height-modulated POSTNET bar codes.

FIG. 10 is a pattern example of a POSTNET bar code.

### DETAILED DESCRIPTION OF THE INVENTION

The present description is directed in particular to elements forming part of, or cooperating more directly with, apparatus in accordance with the invention. It is to be understood that elements not specifically shown or described may take various forms well known to those skilled in the art.

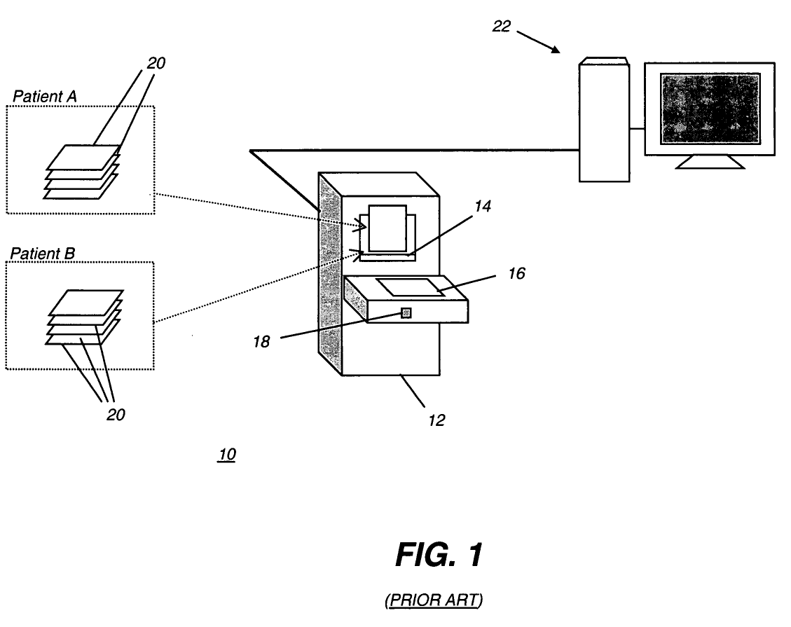

The method and apparatus of the present invention provide a flexible mechanism for demarcation or differentiation between different sets of patient images that can be used in a high-resolution scanner such as that described with reference to FIG. 1, but without requiring a bar code reader or requiring separate steps by an operator to scan encoded information that distinguishes images for one patient from images for another patient.

The present invention is directed to an apparatus and method for organizing and scanning patient films using a case divider. More particularly, the method and apparatus of the present invention provide a case divider that is inserted directly into the scanner along with a set of images for a patient, where the case divider includes a pattern that can be readily detected by the scanner to indicate its function and to differentiate this set of images from any other set of images to be scanned. The case divider of the present invention may include encoded information in some embodiments; however, as will be seen from the subsequent description, it may not be required that specific encoded information be provided other than to identify case divider function, depending upon the workflow sequence that is employed.

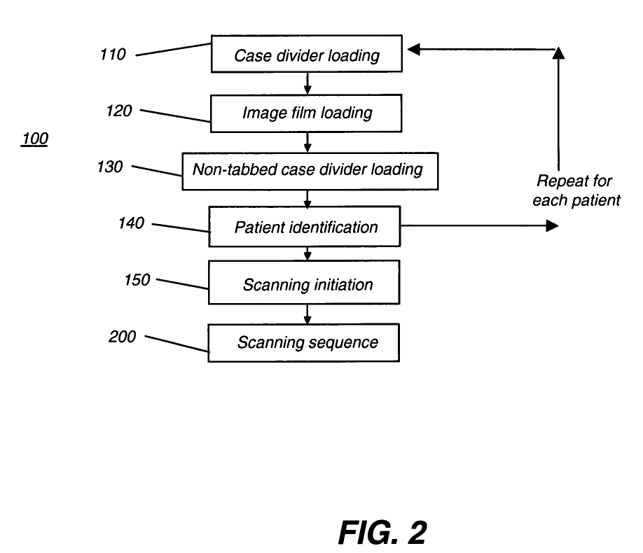

Referring to FIG. 2, there is shown a flow diagram with operator steps for a scanning setup sequence 100 using the case divider according to one embodiment. In this workflow, a case divider loading step 110 is executed initially, in which the operator loads a tabbed case divider, described subsequently, into the feed mechanism of the scanner.

A patient image film loading step 120 follows, in which the operator loads a set of films from the patient jack; in a typical embodiment this includes films taken from a mammography exam.

In an optional non-tabbed case divider loading step 130, the operator may load additional films for the same patient, such as films taken from previous exams.

An identification step 140 follows, during which the operator enters some type of case or patient ID number related to the films just loaded, such as at control panel 16 (FIG. 1) or at workstation 22.

Steps 110, 120, 130, and 140 can then be repeated as many times as needed for each additional patient whose set of images are to be scanned.

Once all of the films and case dividers for a scanning session have been loaded, the operator initiates scanning in a scanning initiation step 150. A scanning sequence 200 is then begun.

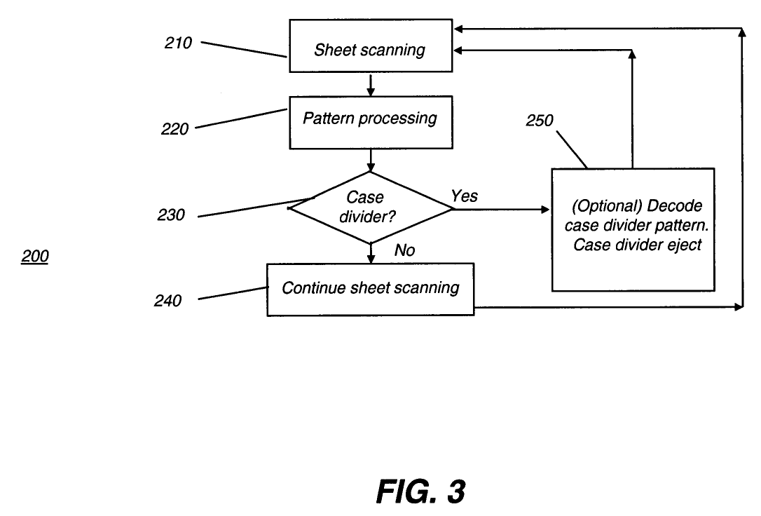

Referring to FIG. 3, there is shown a flow diagram of scanning sequence 200 that is executed by the scanner according to pre-programmed instructions. In a sheet scanning step 210, the scanner begins a high resolution scan of the sheet that is currently loaded in its feeder. It must be emphasized that sheet scanning step 210 is a full resolution scan that begins regardless of whether the sheet is a film or a case divider. During an initial portion of this scan, scanner software executes a pattern processing step 220 that employs a pattern detection algorithm. Once some initial portion of the sheet has been scanned, pattern processing step 220 checks for whether or not the scanned data includes the pattern representing a case divider. In a decision step 230, processing determines whether or not the pattern has been detected. If a case divider pattern has not been detected, the high resolution scan continues. The balance of the sheet is scanned in a scan continuation step 240 in order to obtain the high resolution image data required for a patient image.

If, on the other hand, the case divider pattern is detected, the scanner may initiate an optional pattern decoding detection sequence, described subsequently, as part of a case divider response step 250.

Case divider response step 250 takes some action that differentiates the preceding set of image data from the following set of image data. In one embodiment, case divider response step 250 stores a demarcation code in the data that indicates that the images that will follow must be associated with a different patient case or session and must thus be indexed differently from images that preceded the case divider. In one embodiment, a tabbed case divider indicates that the associated set of images is for a different patient; a non-tabbed case divider indicates that these images are for a different exam session or are otherwise distinguishable from the preceding, or following, set of images for the same patient. Different patterns may be used to differentiate tabbed from non-tabbed case dividers.

At the completion of scanning sequence 200, the operator restores the films to patient records folders for safekeeping.

The case divider of the present invention helps to define distinct sets of film images as they are provided for scanning, but does not need to be, itself, encoded with any data specific to a particular patient. Stacked either ahead of or just following a set of films for a patient, the case divider is designed to be scanned along with the patient films, as if it were a film sheet, but without requiring the time and computational resources needed for full-scale image scanning.

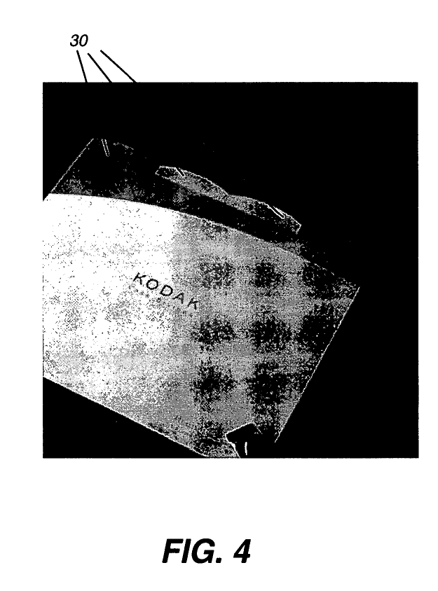

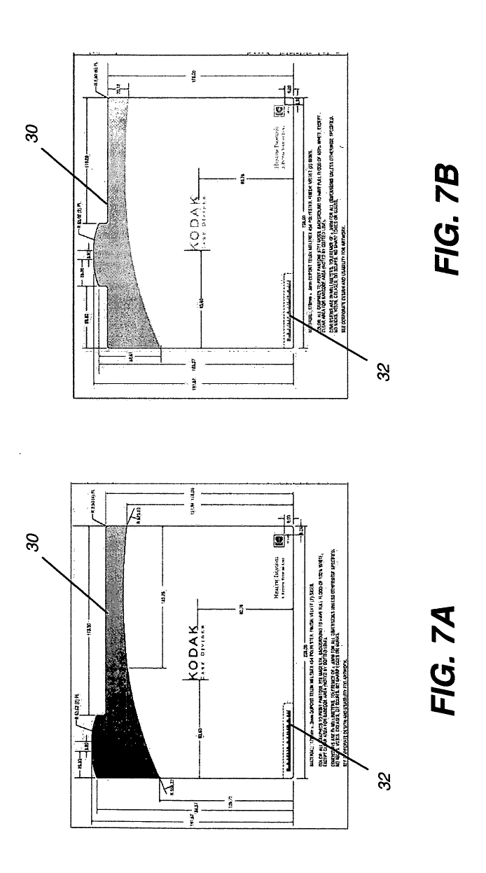

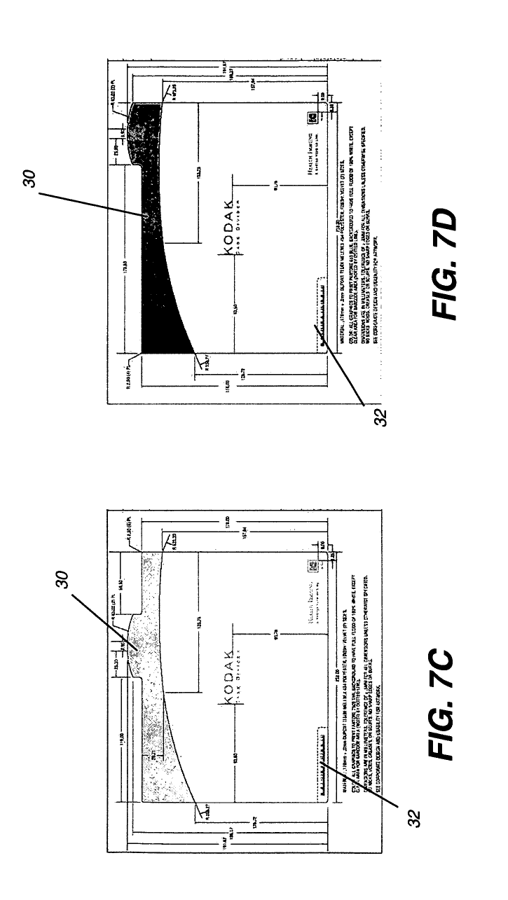

Referring to FIG. 4, there is shown a perspective view of a group of case dividers 30 in one embodiment. Here, case divider 30 is tabbed and color-coded. As shown in FIGS. 7A, 7B, 7C, and 7D, each tab position is associated with a corresponding color. Color coding can be used in a number of ways. In its simplest application, color helps the operator to readily distinguish one set of films from another or to determine, at a glance, how many sets of films are to be processed. In other embodiments, color coding can also be used to classify cases. Colors could be correlated with patient condition, with the number of films associated with a case, with the attending physician or caretaker, or with other characteristics of a case.

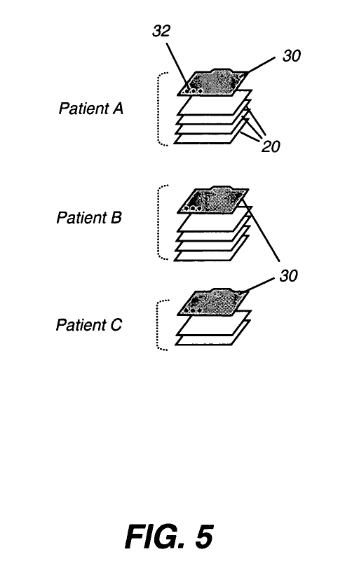

FIG. 5 is a diagrammatic view showing the use of case dividers for separating the images for multiple patients, here shown as Patients A, B, and C. In this example, one case divider 30 is disposed on top of the stack of films 20 for each patient. Each case divider 30 has a pattern 32, some type of marking that may be the same pattern 32 on each case divider 30 or may be a different pattern 32, such as a pattern 32 that encodes information related to the patient.

Where case divider 30 is used only as a separator, it is only necessary that case divider 30 be used between sets of films 20. Thus, for the 10 films shown in the example of FIG. 5, only two case dividers 30 would be needed at a minimum, one placed between the set of images for Patient A and the set of images for Patient B, the other between respective sets of images for Patients B and C.

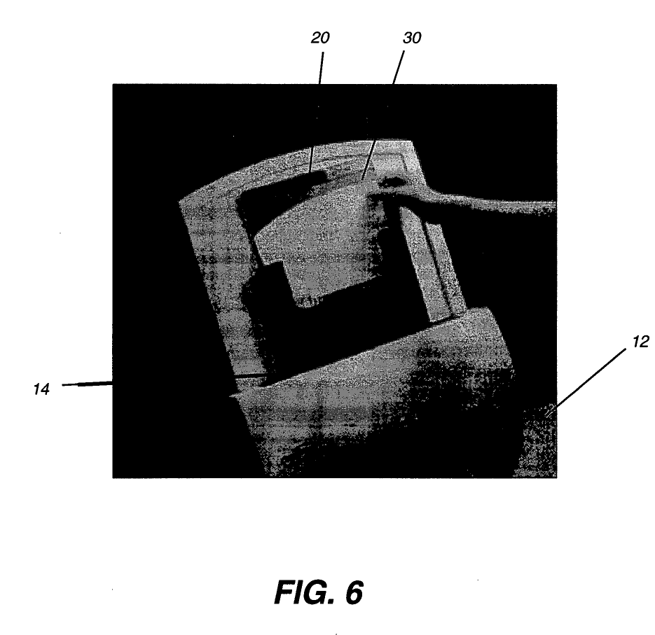

Referring to FIG. 6, there is shown a perspective view showing case dividers 30 and patient images 20 loaded into input feed slot 14 of scanner 12 in one embodiment. The type of scanner 12 determines how many sheets can be loaded at one time and sheet orientation. The present invention allows loading of any number of sheets and uses scanner 12 data in order to distinguish between film images and case dividers 30.

FIGS. 7A, 7B, 7C, and 7D are plan views showing tabbed and color-encoded case dividers 30 in one embodiment. Four different tab positions and colors are shown in this example. Because case dividers 30 are input for scanning along with films 20, the dimensions of case, dividers 30 are compatible with the feed mechanism of scanner 12. In one embodiment, the width and height of case divider 30 is substantially the same as the width and height of associated films 20.

Case divider 30 can be fabricated from any suitable sheet material for scanner feeding, such as paper-based or plastic materials. In one embodiment, a plastic material is used, with the thickness of case divider 30 heavier than film thickness. A suitable material for one embodiment was a type of Teijin Melinex™ film (0.007 in. thickness) from DuPont Teijin Films, Inc., Wilmington, Del. Use of a durable plastic allows case divider 30 to be used multiple times, with possible reuse as many as 1,000 or more times. Various types of coatings could be used to facilitate scanner feeding and to minimize sticking to the film, smudging, dirt pickup, and other undesirable effects.

Regarding pattern 32, pattern 32 may be any appropriate marking, imprinted or otherwise formed on case divider 30, that is detectable in the line scan performed by scanner 12. In some embodiments, pattern 32 may simply be a characteristic pattern that does not vary from one case divider 30 to another. In other embodiments, a set of different patterns 32 may be used, possibly correlated with the background color of case divider 30 or with a tabbed position. In yet other embodiments, pattern 32 may encode information of some type relative to the patient or to some characteristic of the associated films 20.

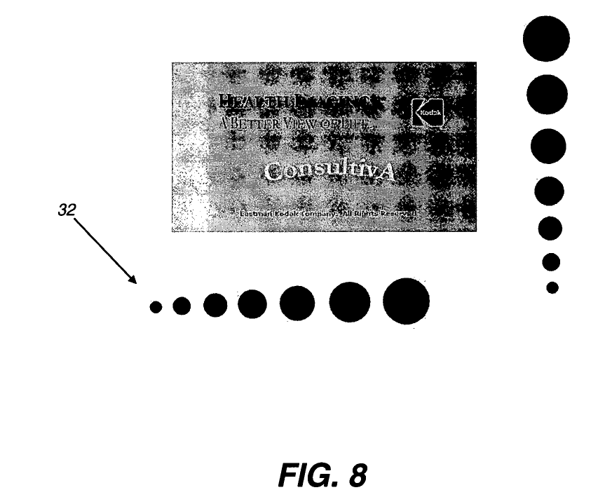

FIG. 8 is a plan view of a an exemplary pattern 32 used on case divider 30 in one embodiment. As shown, a pattern of circles is printed on case divider 30. A line scan of this type of pattern 32, sensing optical density and taken in either the horizontal or vertical direction, would be enabled to quickly detect the spaced, abrupt transitions between high densities of the circles and the low background density. This type of pattern 32 would be fairly robust when printed on case divider 30, able to withstand contact and handling without degradation, for numerous uses.

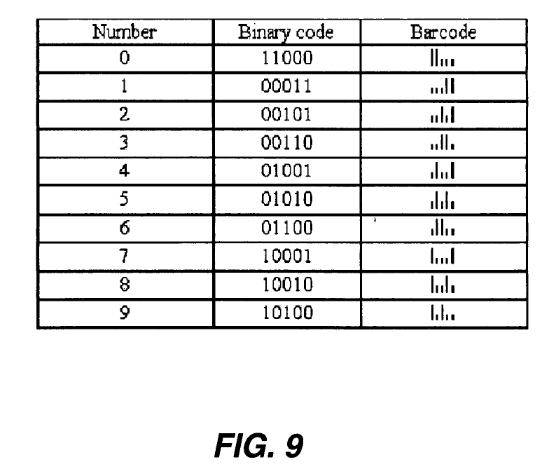

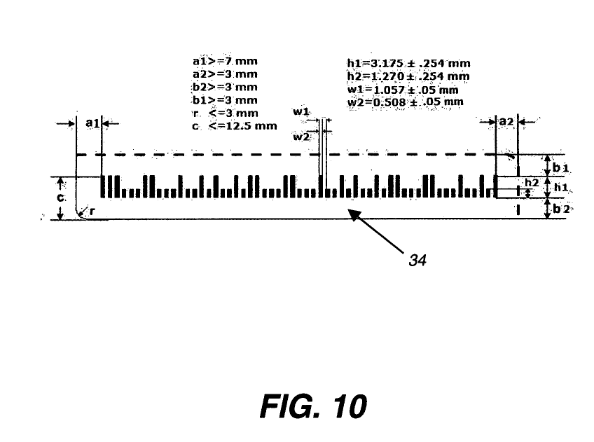

As is shown in FIG. 10, a bar code 34 could alternately serve as pattern 32. Using the encoding scheme outlined in the table of FIG. 9, bar code 34 (shown as a POSTNET (POSTal Numeric Encoding Technique) barcode in FIG. 10) could provide additional information related to a case. Unlike other types of bar codes, POSTNET encodes data in the height of the bars instead of in the widths of the bars and spaces. This symbology, used extensively by the US Postal Service, is relatively easy to implement, straightforward to decode, and typically inexpensive to print. POSTNET is a fixed dimension encoding, for which the height, width and spacing of all bars must fit within exact tolerances. (The specification for postal bar code is publicly available, contained in chapter 5 of Automation-Compatible Mail, DMM Issue 43, Jun. 21, 1992, available from the Postal Service, and Letter Mail Barcode Update, May, 1982, available from the Postal Service.)

For example, bar code 34 could include a patient identifier of some kind, allowing an automated correlation between the set of films 20 immediately following (or immediately preceding) case divider 30 in the stack and a patient. Bar code 34 could be imprinted on an adhesive medium that is adhered onto case divider 30 as part of a records handling workflow. Alternately, bar code 34 could be permanently printed onto case divider 30, serving merely as a pointer, with correlation between its fixed code and the patient stored in a table or database accessible to workstation 22. In yet another alternate embodiment, bar code 34 could be printed temporarily onto an area of case divider 30 and retained as long as needed to scan and store films 20. For example, an electrophoretic or “electronic paper” portion of case divider 30 could be used for forming pattern 32, allowing pattern 32 to be customized for a particular hospital or institution. An electronically re-writable pattern can be written onto case divider 30 with encoded information that suits the handling of a particular case. This information can later be electronically erased, allowing case divider 30 to be re-used numerous times.

Still other types of patterns 32 that can be used include perforations or notches made in the sheet material of case divider 30. Any type of marking that can be optically scanned and detected from case divider 30 can be employed for forming pattern 32.

As was described with regard to the scanning sequence 200 flow diagram of FIG. 3, scanner 12 performs pattern processing step 220 that employs a pattern detection algorithm. Possible strategies for bar code recognition can include intensity-based and gradient-based methods, such as using a Sobel detector, employing techniques familiar to those skilled in the image analysis arts. Representative detection schemes for bar codes are described, for example, in U.S. Pat. No. 5,073,954 entitled “Bar Code Location and Recognition System” to Van Tyne et al. and in U.S. Pat. No. 6,708,884 entitled “Method and Apparatus for Rapid and Precision Detection of Omnidirectional Postnet Barcode Location” to Su et al.

Pattern processing step 220 is preferably executed early in the scan sequence so that when a case divider is detected, a full, high-resolution scan of the full surface of case divider 30 is not needed. To facilitate scanning and handling speed, pattern 32 is preferably positioned in the portion of case divider 30 that is nearest the first portion scanned. For example, with reference to FIG. 6 and 7A, the feed edge of case divider 30 (the first portion of the sheet that is scanned) is along the bottom of the sheet. With proper positioning of pattern 32, then, only a small portion of case divider 30 need be scanned in order to determine that it is not a sheet of film 20 but is, rather, a case divider.

Once scanner 12 software determines that the sheet that is currently being scanned is not film, but is a case divider 30, appropriate action is taken, as part of case divider response step 250, to stop the high resolution scan at an appropriate point and to respond appropriately to pattern 32.

In the simplest case, where case divider 30 has no encoded information specific to the accompanying films 20, scanner 12 can merely record that case divider 30 was detected in this position and then eject case divider 30 in order to continue scanning the next sheet. In other embodiments, scanner 12 performs a decoding sequence that decodes encoded information in pattern 32. The complexity of the decoding sequence is determined by how the information is encoded, by how the encoding is positioned, including whether the encoding is in a fixed or variable position, and by how much information is stored. For POSTNET bar code applications, for example, decoding for an angularly skewed encoding may be needed, such as that described in U.S. Pat. No. 5,155,343 entitled “Omnidirectional Bar Code Reader with Method and Apparatus for Detecting and Scanning a Bar Code Symbol” to Chandler et al.; in U.S. Pat. No. 5,428,211 entitled “Postnet Bar Code Decoder” to Zheng et al.; and in U.S. Pat. No. 5,319,181 entitled “Method and Apparatus for Decoding Two-Dimensional Bar Code Using CCD/CMD Camera” to Shellhammer et al. In one embodiment, a template-matching decoding technique has been found to be particularly efficient for decoding a POSTNET bar code provided on case divider 30.

As a practical consideration, there should be sufficient contrast between pattern 32 and the background of case divider 30. Scanner 12 in most embodiments for mammography and other X-ray images is monochromatic, sensing optical density. Accurate and fast pattern detection would be facilitated by making sure that pattern 32 stands out in high contrast against its background. For example, it has been found desirable to maintain the background optical density at no more than 0.8 (Status T) with the optical density of pattern 32 marks at least 0.5 optical density units higher.

Unlike conventional workflow methods requiring a separate barcode scanner and necessitating additional operator procedures for obtaining a bar code scan, the method of the present invention employs a case separator sheet that is processed automatically using the high-resolution scanner. Where there is encoded information on the case separator itself, such as in a bar code, this method makes use of the high-resolution film scanner system itself for obtaining and decoding the encoded information.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention. For example, different types of case dividers 30 could be used between and within cases, so that not only are patient cases kept distinct, but earlier and later exam results for a particular patient can also be distinguished. Alternate types of bar codes could be employed for pattern 32, as well as other standardized or proprietary encoding schemes. The method and apparatus of the present invention could be combined with other techniques for coupling information to scanned images, including use of an attached memory storage device in addition to a scannable pattern.

The invention has particular advantages for use with systems that scan and digitize mammography images and can also be used for scanning systems that digitize other types of diagnostic images from a film medium, such as X-ray chest film images, or other types of X-ray, ultrasound, or other images. In a broader context, the apparatus and method of the present invention could be used for processing any type of scanned and digitized image or document including text documents, particularly where it is beneficial to differentiate one set of documents from another.

### PARTS LIST

10 Computer-Aided Diagnosis (CAD) system
12 Scanner
14 Input feed slot
16 Control panel
18 Barcode scanner
20 Film
22 Workstation
30 Case divider
32 Pattern
100 Scanning setup sequence
110 Case divider loading step
120 Image film loading step
130 Non-tabbed case divider loading step
140 Identification step
150 Scanning initiation step
200 Scanning sequence
210 Sheet scanning step
220 Pattern processing step
230 Decision step
240 Scan continuation step
250 Case divider response step

1. A method for scanning a set of film images for a patient, the method comprising the steps of:
assembling the set of film images for scanning;
providing a case divider for positioning at the beginning or end of the set of film images to serve as an indicator that differentiates the set of film images from other film images to be scanned, wherein the case divider is a separate sheet and includes a case divider pattern indicating its function as a case divider;
scanning the set of film images along with the case divider to obtain scanned image data; and
detecting the case divider pattern in the scanned image data to identify the case divider.

2. The method of claim 1 further comprising the step of ejecting the case divider when the pattern is detected.

3. The method of claim 1 wherein the pattern includes a bar code.

4. The method of claim 3 wherein the bar code is POSTNET-encoded.

5. The method of claim 1 wherein the pattern is a printed pattern.

6. The method of claim 1 wherein the pattern is electronically re-writable.

7. The method of claim 1 wherein the pattern has at least one perforation.

8. The method of claim 1 wherein the pattern is an encoded pattern.

9. The method of claim 1 wherein the set of film images include mammography images.

10. The method of claim 1 wherein the set of film images include X-ray chest images.

11. The method of claim 1 further comprising the step of obtaining encoded information from the case divider pattern on the case divider.

12. The method of claim 1 wherein the step of providing a case divider comprises the step of selecting a color coded case divider, the color encoding indicating information relevant to the patient's medical condition.

13. A case divider adapted to be processed by an optical scanning apparatus, wherein the case divider is associated with a set of one or more images to be scanned by the optical scanning apparatus, wherein the case divider is scanned either immediately preceding or immediately following the set, and wherein the case divider bears a marking that indicates its function when scanned.

14. A case divider according to claim 13 wherein the marking is a bar code, and the bar code is in POSTNET form.

15. A case divider according to claim 13 wherein the marking is a pattern.

16. A case divider according to claim 13 wherein the marking is an encoded pattern, and the encoded pattern comprises information identifying a patient.

17. A case divider according to claim 13 wherein the case divider is color coded.

18. A case divider according to claim 13 wherein the marking is electronically re-writable.

19. A case divider according to claim 13 wherein the images are formed on a film medium.

20. A case divider according to claim 13 wherein the images include text documents.
